(19) United States
(12) Patent Application Publication
(10) Pub. No.: US 2019/0250469 A1
(43) Pub. Date: Aug. 15, 2019

(54) METHOD OF PRODUCING SUBSTRATE FOR LIQUID CRYSTAL PANEL

(71) Applicant: Sharp Kabushiki Kaisha, Sakai City (JP)

(72) Inventors: Kohshiroh TANIIKE, Sakai City (JP); Toshihiro BABA, Sakai City (JP)

(21) Appl. No.: 16/272,651

(22) Filed: Feb. 11, 2019

(30) Foreign Application Priority Data
Feb. 13, 2018 (JP) 2018-022815

(51) Int. Cl. G02F 1/1337; G02F 1/1341

(52) U.S. Cl. CPC G02F 1/133784; G02F 2001/13415; G02F 1/1341

(57) ABSTRACT

A method of producing a substrate for a liquid crystal panel includes rubbing of performing rubbing processing along a rubbing direction on an alignment film formed on a substrate and cleaning of blowing gas to the alignment film along the rubbing direction of the rubbing processing after the rubbing.

### CROSS REFERENCE TO RELATED APPLICATION

This application claims priority from Japanese Patent Application No. 2018-22815 filed on Feb. 13, 2018. The entire contents of the priority application are incorporated herein by reference.

### TECHNICAL FIELD

The technology described herein relates to a method of producing a substrate for a liquid crystal panel.

### BACKGROUND

A method that includes a process of blowing air onto a substrate to remove foreign substances has been conventionally known as a method of producing a substrate for a liquid crystal panel. An example of such a method is disclosed in Japanese Unexamined Patent Application Publication No. H05-341278.

Now, a substrate for a liquid crystal panel having alignment films is known, and after the alignment films are formed, air is blown onto the alignment films to remove foreign substances on the alignment films. In this case, there is a concern that a situation may arise in which the foreign substances that are blown away scratch the alignment films on the substrate, and the alignment performance of liquid crystals in the alignment films may be deteriorated.

### SUMMARY

The technology described herein was made in view of the above circumstances. An object is to remove foreign substances on an alignment film while alignment performance of the liquid crystals being less likely to be deteriorated.

A method of producing a substrate for a liquid crystal panel of the technology described herein includes rubbing of performing rubbing processing on an alignment film formed on a substrate along a rubbing direction, and cleaning of blowing gas to the alignment film along the rubbing direction of the rubbing processing after the rubbing. In the cleaning, foreign substances on the alignment film can be blown away by blowing the gas onto the alignment film. By blowing the gas along the rubbing direction of the rubbing processing, the foreign substances are easily blown off along the rubbing direction of the rubbing processing. Consequently, a situation is prevented in which the alignment film is scratched by the foreign substances that are blown off in a direction different from the rubbing direction of the rubbing processing, therefore, the alignment performance of the liquid crystal can be suppressed from being deteriorated.

According to the technology described herein, the foreign substances on the alignment film can be removed while the alignment performance of the liquid crystals being less likely to be deteriorated.

### BRIEF DESCRIPTION OF THE DRAWINGS

FIG. 1 is a cross-sectional view of a liquid crystal panel according to an embodiment.

FIG. 2 is a plan view illustrating a mother glass substrate in a step of forming alignment films.

FIG. 3 is a view illustrating the mother glass substrate in a rubbing step.

FIG. 4 is a side view illustrating the mother glass substrate in a first cleaning step.

FIG. 5 is a plan view illustrating the mother glass substrate in the first cleaning step.

FIG. 6 is a plan view illustrating an inspection device in an inspecting step.

FIG. 7 is a side view illustrating the mother glass substrate in a second cleaning step.

FIG. 8 is a plan view illustrating the mother glass substrate in a sealing material applying step.

FIG. 9 is a plan view illustrating the mother glass substrate in a liquid crystal dropping step.

### DETAILED DESCRIPTION

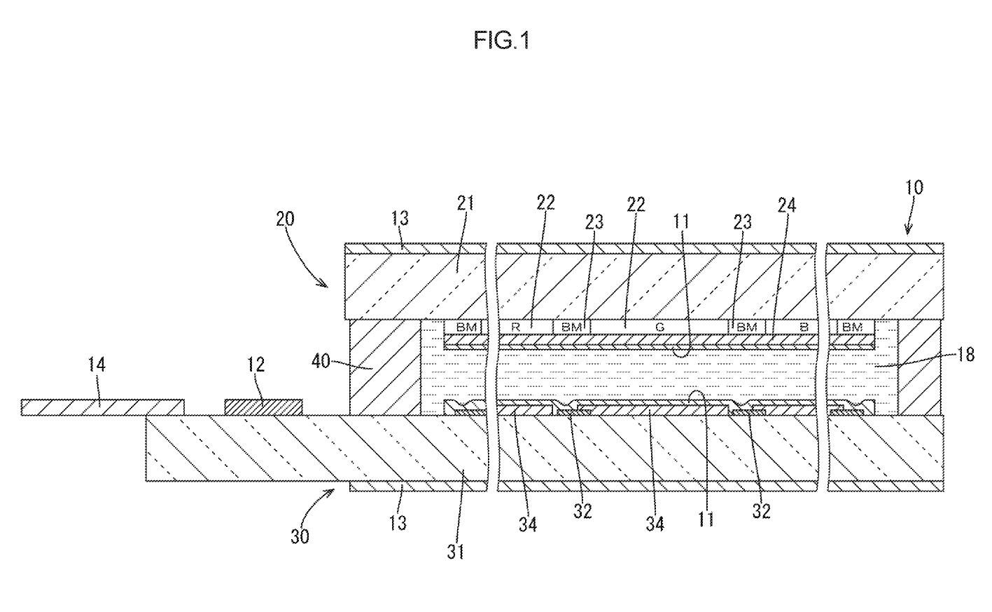

An embodiment of the technology described herein will be described with reference to FIGS. 1 to 9. A liquid crystal panel 10 of the present embodiment has a rectangular shape, and includes, as shown in FIG. 1, a pair of substrates 20, 30 having good light transmission properties, and a liquid crystal layer 18 containing liquid crystal molecules. Among the pair of substrates 20, 30, the substrate 20 on a front side is a color filter substrate (CF substrate) 20, and the substrate 30 on a rear side is an array substrate 30. At least a part of an outer peripheral end part of the array substrate 30 protrudes further outward than an end part of the CF substrate 20 to form a protruded part, and the protruded part is provided with an integrated circuit (IC) chip 12 and a flexible substrate 14. A liquid crystal layer 18 is arranged so as to be sandwiched between both of the substrates 20, 30. The liquid crystal molecules in the liquid crystal layer 18 are substances that undergo change in optical characteristics when the molecules undergo change in alignment with application of an electric field. On inner surface sides of both of the substrates 20, 30, alignment films 11, 11 are provided for aligning the liquid crystal molecules in the liquid crystal layer 18 in a predetermined direction. Here, deflector plates 13, 13 are respectively adhered on the outsides of both of the substrates 20, 30.

The array substrate 30 is configured by arranging thin film transistors (TFTs) 32 being switching elements and pixel electrodes 34 connected to the TFTs 32 in a matrix form on an inner surface side (liquid crystal layer 18 side) of a glass substrate 31. Further, the glass substrate 31 is provided with wiring such as source wiring, gate wiring, and capacitor wiring, so as to partition the TFTs 32. Here, the pixel electrodes 34 are formed of transparent conductive films such as indium tin oxide (ITO) and zinc oxide (ZnO). The above-mentioned alignment films 11 are formed on the inner surface side of the glass substrate 31 so as to cover the TFTs 32 and the pixel electrodes 34 and the like.

The CF substrate 20 is configured by arranging color filters (CFs) 22 including red (R), green (G), and blue (B) filters on an inner surface side (liquid crystal layer 18 side) of a glass substrate 21 in a matrix form. Further, a light shielding layer 23 (black matrix) is formed on the glass substrate 21 so as to partition each CF 22. Then, a counter electrode 24 formed of a transparent conductive film is formed so as to cover the CFs 22 and the light shielding layer 23. The above-mentioned alignment films 11 are formed on the inner surface side of the glass substrate 21 so as to cover the counter electrode 24. Between a pair of the glass substrates 21, 31, a sealing material 40 is arranged so as to surround the liquid crystal layer 18. As the sealing material 40, for example, a known sealing material including ultraviolet curable resin, heat curable resin or the like is used. In the liquid crystal panel 10, by applying a reference potential to the counter electrode 24 of the CF substrate 20 and controlling a potential applied by the TFTs 32 to the pixel electrodes 34, a predetermined potential difference between the pixel electrodes 34 and the counter electrode 24 is generated. Accordingly, the liquid crystal molecules in the liquid crystal layer 18 are aligned in a predetermined direction. Note that in the present embodiment, the liquid crystal panel 10 with a twisted nematic (TN) mode is illustrated; however, a driving mode is not limited to this. For example, the driving mode of the liquid crystal panel may be a horizontal driving mode such as an in-plane switching (IPS) mode or a fringe field switching (FFS) mode.

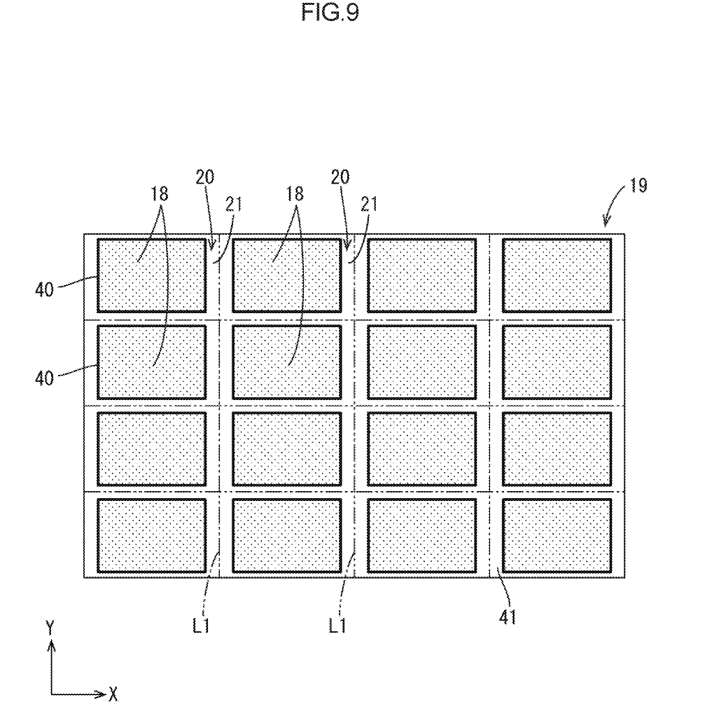

In the present embodiment, a mother CF substrate (refer to FIG. 9) integrally including the CF substrates 20 that are arranged in a matrix form and a mother array substrate integrally including the array substrates 30 that are arranged in a matrix form are produced, respectively. The mother CF substrate 19 and the mother array substrate are bonded to each other to obtain a mother liquid crystal panel. Then, the mother liquid crystal panel is divided into multiple pieces and the liquid crystal panels 10 are produced. The following describes a method of producing the mother CF substrate 19 as one example of a method of producing a substrate for a liquid crystal panel.

A method of producing the mother CF substrate 19 includes: a laminate forming step of forming color filter laminates in a matrix form on a mother glass substrate 41 being a base of the glass substrates 21; an alignment film forming step of forming the alignment films 11 so as to cover the color filter laminates; a rubbing step of performing rubbing processing on the alignment films 11; a first cleaning step of cleaning the mother glass substrate 41; an inspecting step of inspecting the mother glass substrate 41; a second cleaning step of cleaning the mother glass substrate 41; a sealing material applying step of applying the sealing material 40 to the mother glass substrate 41; and a third cleaning step of cleaning the mother glass substrate 41. Note that each of the first to third cleaning steps of the above is an example of the cleaning step performed after the rubbing step.

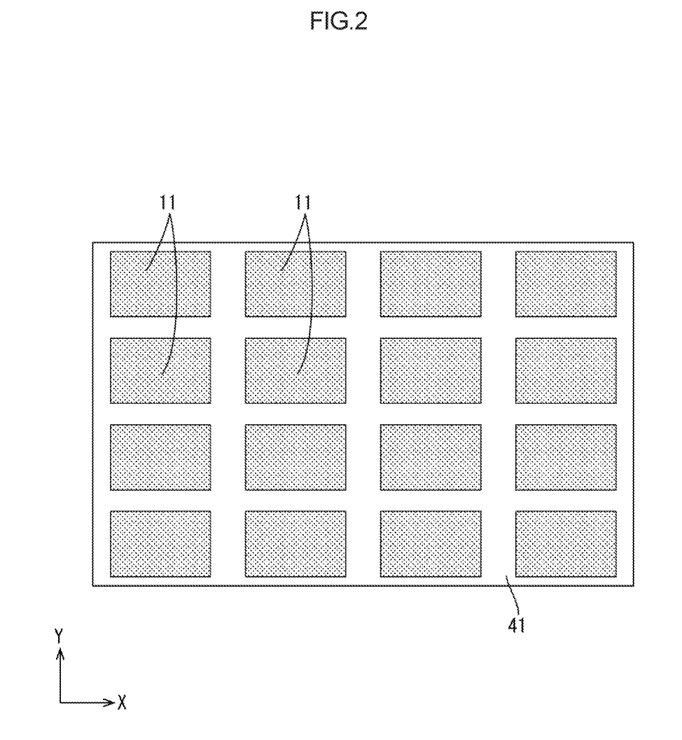

In the laminate forming step, the color filter laminates are formed on the mother glass substrate 41 using a known technique such as a photolithography technique. The color filter laminate described herein is a laminate of the CF substrate 20 including the CF 22, the light shielding layer 23, and the counter electrode 24. In the alignment film forming step performed after the laminate forming step, as shown in FIG. 2, films made of alignment film material is formed on the mother glass substrate 41, and then the films are dried to form the alignment films 11 arranged in a matrix form. Each of the alignment films 11 is formed correspondingly to each of the CF substrates 20. As a method of forming a film made of alignment film material on the mother glass substrate 41, for example, an ink jet system and roll coater system can be used.

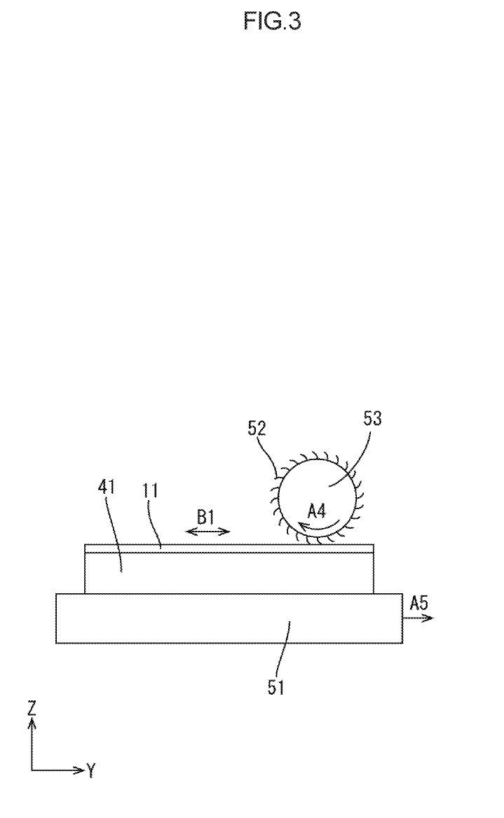

In the rubbing step performed after the alignment film forming step, as shown in FIG. 3, the mother glass substrate 41 is mounted on a stage 51, the stage 51 is moved and passed below a rubbing roller 53 around which a rubbing cloth including pile 52 is wound. In the process of passing the mother glass substrate 41 below the rubbing roller 53, the rubbing processing is performed by the pile 52 rubbing the alignment films 11. In FIG. 2, the rubbing processing is performed along a short side (Y axis direction in FIG. 2) of the mother glass substrate 41. Also, note that in FIG. 3, the rubbing roller 53 rotates clockwise (refer to an arrow A4 in FIG. 3), and the moving direction of the stage 51 is a direction moving from a left side toward a right side (refer to an arrow A5 in FIG. 3). Accordingly, the alignment films 11 are rubbed from the right side toward the left side in FIG. 3 by the rubbing roller 53.

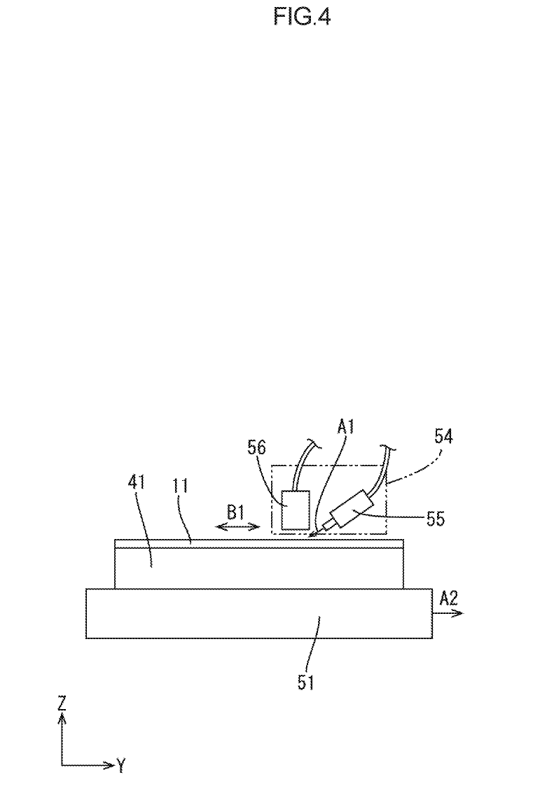

In the first cleaning step performed after the rubbing step, the mother glass substrate 41 is cleaned by using a cleaner 54 shown in FIG. 4. The cleaner 54 is of a so-called blow and vacuum system, and includes an air nozzle 55 that can blow air (gas) onto the mother glass substrate 41 and a vacuum nozzle 56 connected to a negative pressure generator. In the first cleaning step, the mother glass substrate 41 is mounted on the stage 51, and the stage 51 is moved and passed below the cleaner 54. In the process of passing the mother glass substrate 41 below the cleaner 54, the air is blown from the air nozzle 55 onto a surface of the alignment films 11 to blow away foreign substances adhered on the alignment films 11, and then the foreign substances are sucked by the vacuum nozzle 56.

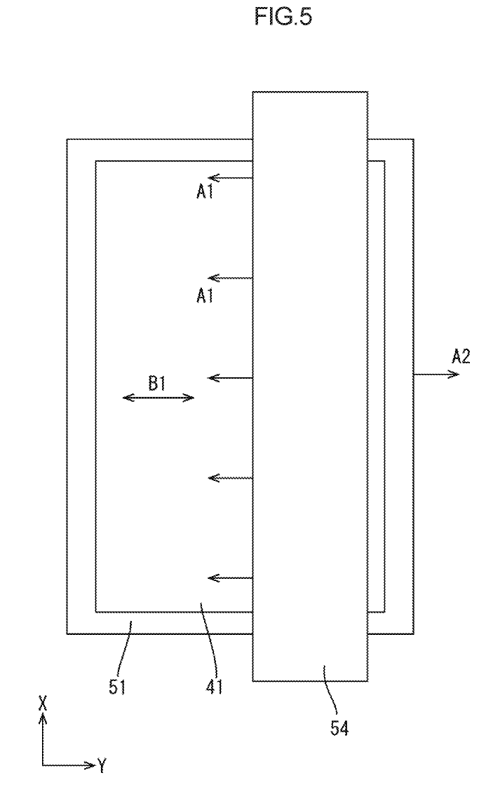

A blowing direction of the air (an arrow A1 in FIG. 4) by the air nozzle 55 (blowing device) is a direction along the short side of the mother glass substrate 41, which is the direction of performing rubbing processing in the rubbing step (rubbing direction, an arrow B1). Note that “the blowing direction of the air is along the direction of the rubbing processing” means that in at least in a planar view (refer to a planar view of the mother glass substrate 41 in FIG. 5), the blowing direction of the air by the air nozzle 55 (blowing device) is parallel with the direction of the rubbing processing, that is, a direction along which liquid crystal molecules are aligned by the alignment films 11.

Here, the air nozzle 55 blows the air from a right side toward a left side in FIG. 4. The vacuum nozzle 56 is arranged on the left side of the air nozzle 55, and therefore, can effectively suck the foreign substances blown away by blowing from the air nozzle 55. Note that the blowing direction of the air nozzle 55 may be parallel to the direction of the rubbing processing in the planar view (a state of FIG. 5), and the air nozzle 55 can blow the air from the left side toward the right side in FIG. 4.

Moreover, as shown in FIG. 5, the cleaner 54 (air nozzle 55 and vacuum nozzle 56) has a longitudinal shape whose length is greater than a long side of the mother glass substrate 41, so that the entire surface (all alignment films 11) of the mother glass substrate 41 can be cleaned by moving the stage 51 with respect to the cleaner 54. Furthermore, the moving direction of the stage 51 (an arrow A2 in FIG. 4) is a direction along the direction of the rubbing processing.

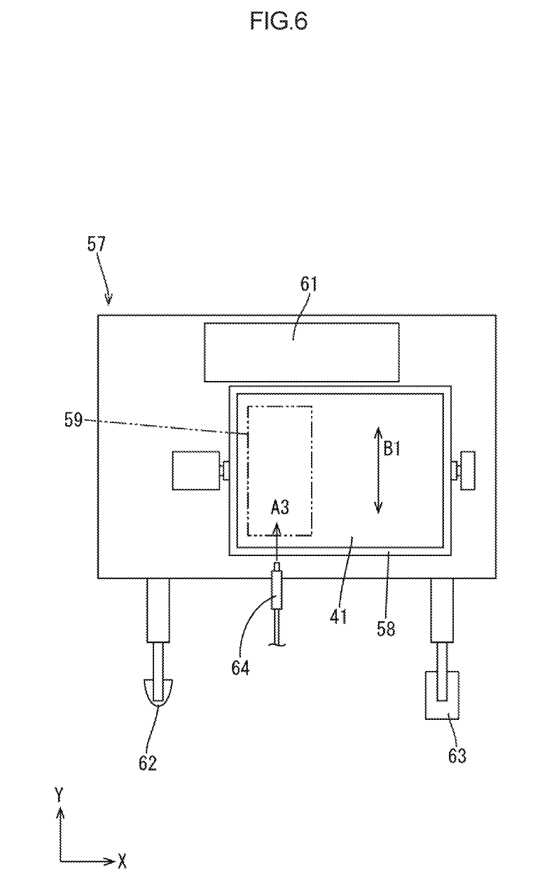

In the inspecting step performed after the first cleaning step, the mother glass substrate 41 is visually inspected by using an inspection device 57 shown in FIG. 6. The inspection device 57 includes a stage 58 on which the mother glass substrate 41 is mounted, a vapor generator 59, and illuminations 61, 62, and 63. The stage 58 is rotatable about an X axis of FIG. 6 as a rotation center. By rotating the stage 58, a posture of the mother glass substrate 41 can be changed. The illumination 61 arranged on a farther side of the stage 58 (upper side in FIG. 6) is, for example, a fluorescent lamp. Further, the illumination 62 arranged on a nearer side (operator side or lower side in FIG. 6) of the stage 58 is, for example, a halogen lamp that can emit white light, and the illumination 63 arranged on the nearer side of the stage 58 is, for example, a mercury lamp that can emit green light. In the inspecting step, the mother glass substrate 41 is held on the stage 58 and is fogged by vapor generated by the vapor generator 59, and thereafter, the stage 58 is rotated to change a posture of the mother glass substrate 41. Meanwhile, the operator visually inspects the mother glass substrate 41 by sequentially using light transmitted from the illumination 61 and light reflected by the illuminations 62, 63. Specifically, the operator visually confirms presence or absence of damages and irregularities that could have been generated by the rubbing processing.

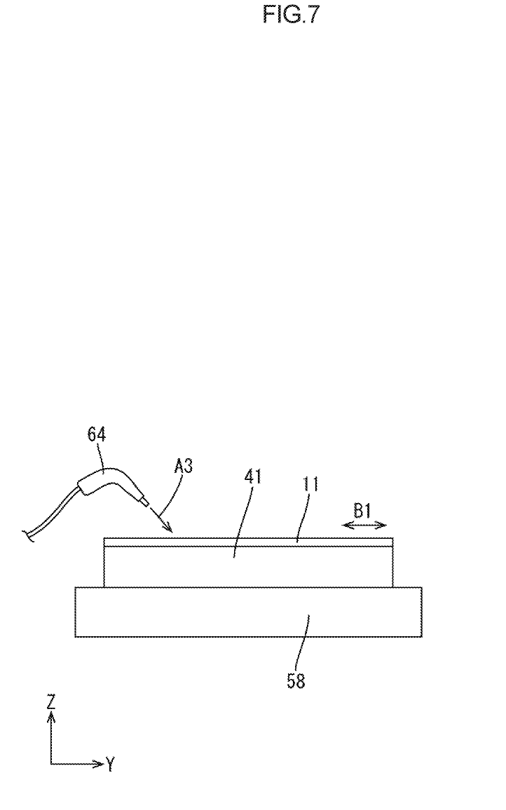

In the second cleaning step performed after the inspecting step, as shown in FIGS. 6 and 7, the operator cleans the mother glass substrate 41 using an air gun 64 in a state where the mother glass substrate 41 being mounted on the stage 58. Specifically, the operator makes air of the air gun 64 be blown onto the surface of the alignment films to blow away the foreign substances adhered on the alignment films 11. A blowing direction of the air (an arrow A3 in FIGS. 6 and 7) by the air gun 64 is a direction along the short side of the mother glass substrate 41, which is the direction of performing the rubbing processing in the rubbing step. That is, in the plan view of FIG. 4, the blowing direction of the air by the air gun 64 is parallel to the direction of the rubbing processing. In the present embodiment, the air is blown by the air gun 64 from the nearer side (lower side in FIG. 6) toward the farther side (upper side in FIG. 6) of the stage 58. Note that a left side in FIG. 7 is the nearer side of the stage 58 and a right side in FIG. 7 is the farther side of the stage 58. Further, in the rubbing step, the alignment films 11 are rubbed from the left side toward the right side in FIG. 7 by the rubbing roller 53.

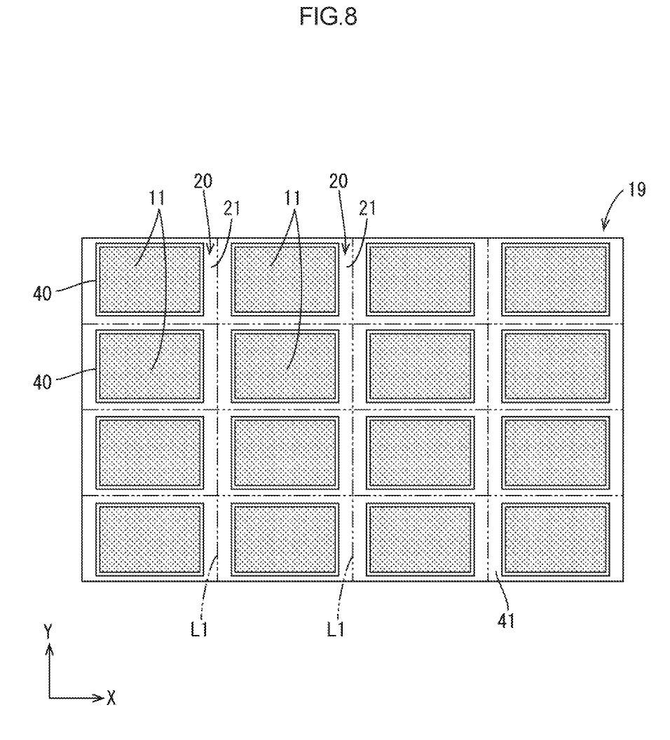

In the sealing material applying step performed after the second cleaning step, as shown in FIG. 8, a sealing material 40 having a frame shape is applied on the mother glass substrate 41 so as to surround each of the alignment films 11. The sealing material 40 can be applied using a predetermined drawing device. Note that as the sealing material 40 formed on the mother glass substrate 41, for example, photocurable material is used, and the sealing material 40 is conveyed to the next step (third cleaning step) in an uncured state. That is, the sealing material applying step is performed between the rubbing step and the third cleaning step (cleaning step).

In the third cleaning step performed after the sealing material applying step, the mother glass substrate 41 is cleaned. A cleaning device used in the third cleaning step is a device having the same configuration as the cleaner 54 in FIG. 4, and a cleaning procedure is also the same as the first cleaning step shown in FIG, 4, therefore, the detailed description is omitted. In other words, in the third cleaning step, a blowing direction of air by the air nozzle 55 (blowing device) is the direction along the rubbing processing in the rubbing step, likewise in the first cleaning step. Note that the third cleaning step differs from the first cleaning step in performing the cleaning operation under a yellow lamp environment in order to prevent curing of the sealing material 40 applied in the previous step.

Moreover, a liquid crystal dropping step of forming the liquid crystal layer 18 is performed after the third cleaning step. In the liquid crystal dropping step, the one drop fill (ODF) method using a liquid crystal dropping device is used to drop liquid crystal onto a portion surrounded by the sealing material 40 in the mother glass substrate 41. Thus, the liquid crystal layer 18 is formed as shown in FIG. 9. Additionally, after the liquid crystal layer 18 is formed, the mother CF substrate 19 and the mother array substrate are bonded together using a bonding device. In the bonding, the sealing material 40 is heated during irradiation (or after the irradiation) with ultraviolet light through the mother CF substrate 19 or mother array substrate. By this, the sealing material 40 is cured and the mother CF substrate 19 and the mother array substrate are bonded together through the sealing material 40 to produce the mother liquid crystal panel. Thereafter, the mother liquid crystal panel is divided, and thereby the liquid crystal panels 10 can be obtained. Note that division lines L1 for dividing the mother CF substrate 19 into the CF substrates 20 are shown in FIGS. 8 and 9 with two-dot chain lines.

Next, effects of the present embodiment are described. In the above cleaning steps (first to third cleaning steps), foreign substances on the alignment films 11 can be blown away by blowing the gas. By blowing the gas along the direction of the rubbing processing, the foreign substances are easily blown off along the direction of the rubbing processing. Consequently, a situation is prevented in which the alignment films 11 are scratched by the foreign substances that are blown off in a direction different from the direction of the rubbing processing, therefore, the alignment performance of the liquid crystal can be suppressed from being deteriorated.

Moreover, in the cleaning steps (first cleaning step and third cleaning step), the air is blown onto the alignment films 11, and the foreign substances scattered from the alignment films 11 are sucked. By sucking the foreign substances scattered by blowing the air, a situation can be suppressed in which the scattered foreign substances are adhered onto the alignment films 11 again. Further, by sucking the scattered foreign substances, the alignment films 11 can be prevented from being scratched by the scattered foreign substances, therefore, a situation can be further suppressed in which the alignment performance of the liquid crystal is deteriorated.

Also, in the cleaning steps (first cleaning step and third cleaning step), the air is blown onto the mother glass substrate 41 mounted on the stage 51 using the air nozzle 55, and the stage 51 is moved along the direction of the rubbing processing with respect to the air nozzle 55. The air can be blown over the entire length of the mother glass substrate 41 in the moving direction of the stage 51 while having the air nozzle 55 fixed. By fixing the air nozzle 55, a situation can be suppressed in which the blowing direction of the air is shifted with respect to the direction of the rubbing processing.

Still further, in the cleaning step (third cleaning step), the air is blown onto the alignment films 11, and also, between the rubbing step and the cleaning step (third cleaning step), the sealing material applying step is performed in which the sealing material 40 having a frame shape is applied on the mother glass substrate 41 so as to surround each of the alignment films 11. After the sealing material 40 is temporarily applied and in a case when wet washing is performed, because there is a concern that the wet washing has adverse effects on the sealing material 40 (such as performance degradation and peeling), the wet washing is difficult to be performed. However, in the third cleaning step performed after the sealing material applying step, because the air is blown onto the alignment films 11 to perform the cleaning, the sealing material 40 can be suppressed from being affected by the adverse effects.

The inventor of the technology described herein has compared a defect rate in the present embodiment with a defect rate of a comparative example for each cleaning step of the first to third cleaning steps. The comparative example is an example in which, in each cleaning step, a blowing direction of the air to the alignment films 11 is made orthogonal to the rubbing direction. Further, the defect rate is an occurrence rate of a defective product due to scratches of the alignment films 11 generated in the cleaning steps. The inventor of the technology described herein has confirmed that, in the first cleaning step, the defect rate of the present embodiment is from 2 to 4%, and the defect rate of the comparative example is from 10 to 20%. Further, it has been confirmed that, in the second cleaning step, the defect rate of the present embodiment is from 3 to 6%, and the defect rate of the comparative example is from 15 to 30% Still further, it has been confirmed that, in the third cleaning step, the defect rate of the present embodiment is from 1 to 2%, and the defect rate of the comparative example is from 5 to 10% As described above, in the cleaning step of any of the first to third cleaning steps, by making the blowing direction of the air be along the rubbing direction, the defect rate can be suppressed down to about one fifth of that of the comparative example.

Note that a cleaning method of a contact type using a brush is known as a substrate cleaning method after the rubbing processing. The cleaning method using the brush is effective in a case of removing shavings of the alignment films generated by the rubbing processing; however, removing is difficult for foreign substances larger than the shavings of the alignment films, for example, pile fabric pieces generated in the rubbing processing from a rubbing cloth. As in the present embodiment, by the cleaning method of the blow and vacuum system using the air nozzle 55 and the vacuum nozzle 56, the pile fabric pieces generated from the rubbing cloth can be removed more reliably. In particular, when a substrate such as a CF substrate or array substrate, a surface on which an irregular structure is formed, is cleaned using a brush, there may be a case that when foreign substances such as pile fabric pieces scraped by the brush adheres on the structure on the substrate again from the brush and is pressed against the substrate, the foreign substances get caught on the structure on the substrate and cannot be removed. A presence of the foreign substances like the above in a display region of a liquid crystal panel could be a cause of arrangement defects. Further, when foreign substances get caught on an alignment mark formed on a peripheral part of a mother glass substrate (a waste end material region after dividing the mother glass substrate), alignment cannot be performed accurately in bonding a mother CF substrate and a mother array substrate together and shifting occurs in the bonding, which could be a cause of color mixing defects due to color shift in color filters. The present embodiment is suitable because the cleaning method of the blow and vacuum system is used to suppress a situation in which the foreign substances adhere again on the substrate.

### Other Embodiments

The technology described herein is not limited to the embodiment described above and with reference to the drawings. The following embodiments may be included in the technical scope.

(1) A substrate for a liquid crystal panel can be any substrate that includes alignment films, and a mother array substrate for producing an array substrate can be exemplified.

(2) In the first cleaning step and the third cleaning step of the above, the air nozzle 55 can be moved with respect to the mother glass substrate 41.

(3) A direction of the rubbing processing may be a direction along a long side of the mother glass substrate 41, or the direction of the rubbing processing may be inclined with respect to a direction of one side (direction of a long side or short side) of the mother glass substrate 41. Moreover, a shape of the mother glass substrate 41 is not limited to the one illustrated in the above embodiment, and may be, for example, a square shape.

(4) Gas to be blown onto the alignment films 11 in the cleaning step is not limited to air. The gas may be any gas that can remove foreign substances on the alignment films 11 by blowing. Here, when the gas to be blown is the air, clean dry air (CDA) is preferred, and when the gas other than the air is blown, inert gas such as nitrogen gas is preferred. When gas containing a large amount of moisture is excessively blown onto the alignment films 11, the moisture is absorbed by the alignment films 11 to cause deterioration in anisotropy of the alignment films 11, which raises a concern of causing a situation in which alignment control ability of liquid crystal deteriorates. Also, when blowing active gas onto the alignment films 11, there is similarly a concern that a situation may arise in which the alignment control ability deteriorates. By using CDA or inert gas as the gas to be blown, the situation of the alignment control ability being deteriorated can be suppressed.

1. A method of producing a substrate for a liquid crystal panel, the method comprising:
rubbing of performing rubbing processing along a rubbing direction on an alignment film formed on a substrate; and
cleaning of blowing gas to the alignment film along the rubbing direction of the rubbing processing after the rubbing.

2. The method of producing a substrate for a liquid crystal panel according to claim 1, wherein the cleaning includes blowing the gas onto the alignment film and sucking a foreign substance scattered from the alignment film.

3. The method of producing a substrate for a liquid crystal panel according to claim 1, wherein the cleaning includes blowing the gas onto the substrate mounted on a stage using a blowing device, and the stage is moved along the rubbing direction of the rubbing processing with respect to the blowing device.

4. The method of producing a substrate for a liquid crystal panel according to claim 1, the method further comprising applying a sealing material having a frame shape onto the substrate so as to surround the alignment film, the applying being performed between the rubbing and the cleaning.
